(19) United States
(12) Patent Application Publication
(10) Pub. No.: US 2021/0185786 A1
(43) Pub. Date: Jun. 17, 2021

(54) LANDSCAPE LIGHTING AND SECURITY SYSTEM AND METHOD

(71) Applicant: Richard G. Bennette, Boerne, TX (US)

(72) Inventor: Richard G. Bennette, Boerne, TX (US)

(21) Appl. No.: 17/103,033

(22) Filed: Nov. 24, 2020

Related U.S. Application Data
(60) Provisional application No. 62/946,595, filed on Dec. 11, 2019.

(51) Int. Cl. H05B 47/13; H05B 47/16; H05B 47/11; F21S 9/02

(52) U.S. Cl. CPC H05B 47/13; H05B 47/16; F21W 2131/109; F21S 9/02; H05B 47/11

(57) ABSTRACT

A landscape lighting and security system includes low-voltage landscape light fixture electrically coupled to a low-voltage power line extending from a low-voltage landscape transformer. A control device connects to the transformer, such as in place of a common photo cell. When a motion detection sensor of the control device is activated, the transformer powers and illuminates the landscape light fixtures.

### RELATED APPLICATIONS

This application claims the benefit of U.S. Provisional Application No. 62/946,595, filed on Dec. 11, 2019.

### BACKGROUND OF THE INVENTION

The present invention generally relates to landscape lighting. More particularly, the present invention relates to a controller for landscape lighting transformers for actuating the landscape lighting to also serve for security and safety purposes.

In a typical landscape lighting installation, a transformer is used to supply low voltage power to light fixtures. Landscape lighting transformers are most often equipped with a timer that turns the lights on at a specific hour and off after a predetermined period of time. Landscape lighting transformers may also be equipped with remote or built-in photocells that automatically turn the transformers on at dusk and either off at a predetermined time or at dawn. Once the transformer turns off, there is no way to automatically turn the transformer back on.

Smart home devices that connect between a landscape lighting transformer and landscape light fixtures are known. However, they also do not have the ability to automatically turn the lights on after the transformer is turned off.

The ability for the lights to be automatically turned back on when an intruder moves through or near the landscape lighting area is desirable. Also, it often happens that users who install landscape lighting may arrive after their landscape lights have turned off. A device that would automatically turn the landscape lights back on would be desirable as a way to light walkways or aid in finding one's way through an otherwise dark passage. The present invention fulfills these needs and provides other related advantages.

### SUMMARY OF THE INVENTION

The present invention is directed to a landscape lighting and security system, and related method. The present invention incorporates a control device into a landscape lighting system such that when the control device detects the motion of a passerby the transformer is actuated so as to power and illuminate the low-voltage landscape lighting fixtures electrically coupled to the transformer.

The system of the present invention comprises a low-voltage landscape transformer. One or more low-voltage landscape light fixtures are electrically coupled to a low-voltage power line extending from the transformer. A control device is operably coupled to the transformer and includes a motion detection sensor which, when activated, causes the control device to send a signal to the transformer to power and illuminate the one or more landscape light fixtures.

The control device may include a selectable timer for actuating the transformer to power the landscape light fixtures during or for a selected period of time. The control device may also include a photo cell for actuating the transformer when ambient light falls below a predetermined level.

The control device may be powered by a battery. The control device may be electrically coupled to the low-voltage power line for electrically charging a rechargeable battery of the control device.

A stake may extend from the control device for selectively positioning the control device in the ground. Additionally, or alternatively, the control device may include apertures for mounting the control device on a wall or other generally vertical surface.

In accordance with the method of the present invention for providing security lighting, one or more low-voltage landscape light fixtures are electrically coupled to a low-voltage landscape transformer via a low-voltage power line extending from the transformer. A control device having a motion detector sensor is coupled to the transformer. The motion detector sensor may comprise a passive, infrared motion sensor. The transformer is activated to provide power to and illuminate the landscape light fixtures when the sensor detects motion.

Power may be provided to the landscape light fixtures for a predetermined period of time after the transformer is activated.

The control device may activate the transformer when a photo cell of the control device detects ambient light falling below a predetermined level.

A battery of the control device may be recharged using low-voltage electricity from the transformer.

A photo cell coupled to the transformer may be replaced with a control device. The control device may be mounted near an area to be monitored for passersby.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic illustration showing a typical landscape lighting system which includes the security control device of the present invention; and

FIG. 2 is an enlarged view of the security controller of FIG. 1.

### DETAILED DESCRIPTION OF THE PREFERRED EMBODIMENTS

As shown in the accompanying drawings, for purposes of illustration, the present invention is directed to a landscape lighting and security system, generally referred to by the reference number 10. The system 10 of the present invention interrupts a preprogrammed, timed setting to turn the lights back on, so as to illuminate walkways, driveways, patios, etc., after the preprogrammed time setting have turned the lights off.

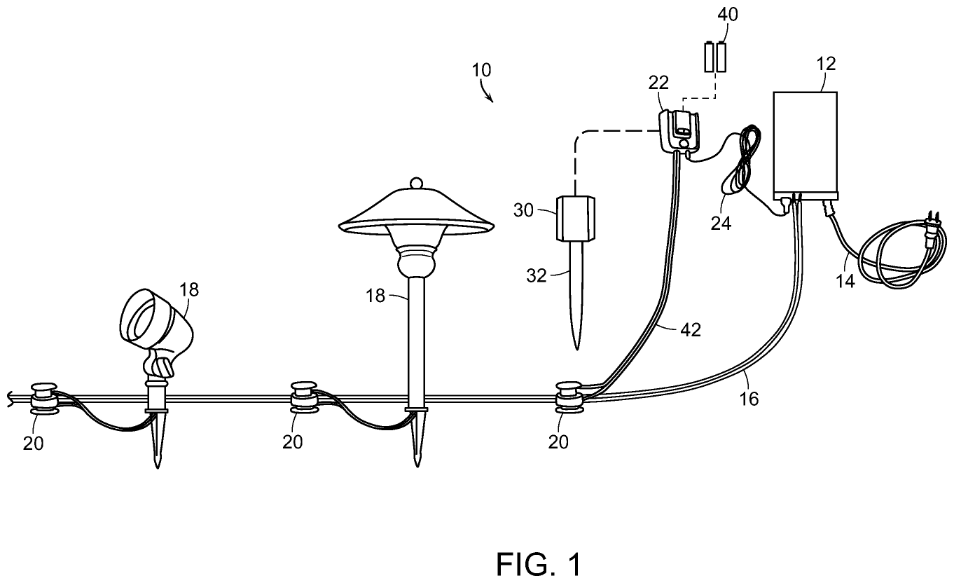

With reference now to FIG. 1, the system 10 of the present invention comprises a low-voltage landscape transformer 12. The transformer 12 typically has a power cord and plug 14 which can be coupled to a power source, typically a power outlet of a house or other building. Typically, these power outlets provide 120 volts AC. The transformer 12 converts the voltage into a much lower voltage, typically around 12 volts for the landscape lighting components. There are several reasons for using lower voltage, including safety reasons. Such low-voltage transformers 12 are often disposed in entryways, under patios, within garages, etc. where they can be near a wall outlet and protected from adverse weather, such as rain. However, low-voltage transformers 12 for landscaping purposes can also be exposed to the environment with a protective housing or the like.

With continuing reference to FIG. 1, at least one low-voltage power line 16 extends from the transformer 12 and which carries the lower voltage. At least one, and typically several, low-voltage landscape light fixtures 18 are electrically coupled to the low-voltage power line 16 so as to receive power from the transformer 12 and illuminate when power is provided by the transformer 12. The light fixtures 18 may be electrically and conductively coupled to the power line 16 by means of a connector 20, as is known in the art. For example, such connector 20 may include conductive metal barbs or teeth which penetrate the cover of the power line 16 and come into contact with the conductive wiring of the power line 16 so as to conductively couple the light fixture 18 with the power line 16. Such light fixtures 18 are typically spaced apart from one another and placed along walkways, driveways, or are directed to shine light on the house or building, onto trees or other areas of interest of the yard or area surrounding the building.

The transformer 12 typically provides the low-voltage power to the light fixtures 18 for a period of time at night. Traditionally, the transformer 12 may be activated and powered on by a selectable timer and/or a photo cell. The photo cell detects when the ambient light has reached a sufficiently predetermined low level, at which point the transformer 12 is activated to supply electricity to the light fixtures 18. A timer built in or associated with the transformer 12 then provides power to the light fixtures 18 for a preset period of time. For example, once activated, the transformer 12 may run and operate and provide electricity to the light fixtures 18 for a period of time that could comprise an hour, three hours, etc. depending upon the desires of the user. Typically, however, the transformer will cease providing power to the light fixtures 18 at a preselected time. Thus, typically, the photo cell turns on the transformer 12 at dusk and the transformer 12 will operate for a set period of time during which the landscape lights 18 are illuminated.

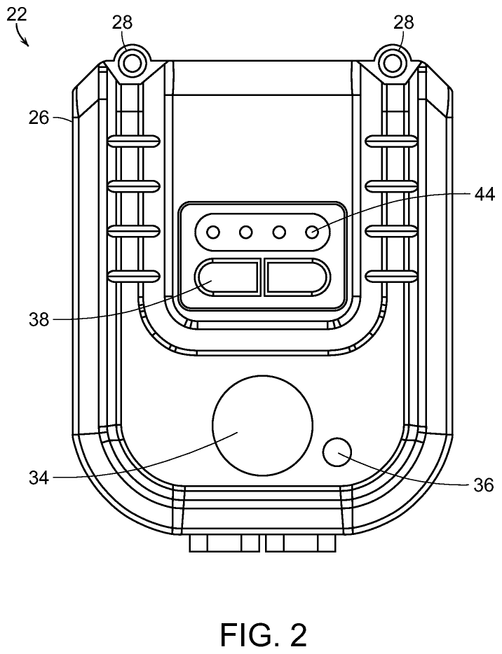

With reference now to FIGS. 1 and 2, in accordance with the present invention, a control device 22 is operably coupled to the transformer 12, such as by means of an electrical cord 24. The control device 22 may be used in place of the traditional photo cell referred to above. This would enable the present invention to be incorporated into existing landscape systems and provide the advantages of the present invention.

The control device 22 detects the presence of an object, such as a person, animal, automobile, etc. and activates the transformer 12 to power on and illuminate the landscape lights 18. This may be useful when the homeowner arrives home after the transformer timer has turned the lights off, or in the advent of an intruder or animal or the like passing through a detection field of the control device 22 so as to alert the homeowner of the presence of the animal, intruder or the like. The activation of the transformer 12 and illumination of the landscaping lights 18 may also serve to scare off the animal, intruder, etc.

With reference to FIG. 2, the control device 22 includes electronic circuitry within the housing 26. The housing may be water resistant or waterproof to provide freedom of placement around the house or building, yard, etc. The housing may include mounting apertures 28 through which fasteners can be inserted for mounting the control device 22 onto a wall or other vertical surface. Alternatively, the control device 22 may be placed near the ground, such as by means of being removably attached to a mounting bracket 30 having a stake 32 extending therefrom for insertion into the ground. In this manner, the control device 22 can be positioned near a doorway, a walkway, a driveway, or an area of the yard surrounding the house or building.

The control device 22 includes a motion detection sensor 34, such as a passive infrared motion sensor. When an object passes through the sensor's zone of coverage, the control device 22 sends a signal via wire 24, to the transformer 12 to activate the transformer to power and illuminate the landscape light fixtures 18.

With continuing reference to FIG. 2, the control device 22 may also include a photo cell 36 which detects the level of ambient light. When the level of ambient light reaches a predetermined low level, such as at dusk, the control device 22 sends a signal to the transformer 12 to activate the transformer to power and illuminate the landscape light fixtures 18. The control device 22 also includes a timer, which may be selected via buttons 38, so that the user may set an operating time of the landscape lights 18.

After the control device 22 turns on the transformer, such as at dusk via the photo cell 36 housed within the control device, after preselected operating times set by the user, the control device 22 sends a signal to the transformer 12 that the transformer recognizes as dawn, thus shutting the transformer 12 off. When motion is detected by the sensor 34, such as when an object passes through the zone of coverage of the sensor, a signal of “dusk” is sent to the transformer 12, thus turning the transformer back on. The transformer 12 powers the landscape light fixtures for a period of time, which is typically predetermined, for example, ten minutes. This time can be factory set.

The control device 22 may be powered by batteries 40. The batteries 40 may be rechargeable and the control device 22 electrically coupled to the transformer 12, such as by means of a power line 42 extending from the control device 22 and electrically coupled and connected to the low-voltage power line 16, such as via a connector 20, which will provide low-voltage electricity to the control device 22 for recharging the batteries 40.

The control device 22 may include a plurality of indicator lights 44 which may assist the user in programming the control device 22, ascertaining the power level of the batteries 40, etc. Buttons 38 may be used to program the control device 22, including a timer of the control device.

The control device 22 may also include a camera, such as a Wi-Fi camera. The purpose of the Wi-Fi camera would be to capture and/or send video of captured movement, such as an animal or intruder or the like, to an owner's computer or wireless device, such as a smartphone or the like.

The combination of a motion sensor 34, timer 38, and photo cell 36 achieves the objectives and usefulness of the present invention by controlling the transformer power source 12 to the exterior lights 18 of the system 10. As mentioned above, as the control device 22 is not built into the transformer 12, it allows the users with existing exterior landscape lighting systems to integrate the control device 22 easily and inexpensively into existing systems and transform them into one that accomplishes the tasks of security lighting and automatic illumination after preprogrammed times have turned off to power the lighting system.

Although several embodiments have been described in detail for purposes of illustration, various modifications may be made without departing from the scope and spirit of the invention. Accordingly, the invention is not to be limited, except as by the appended claims.

What is claimed is:

1. A landscape lighting and security system, comprising:
a low voltage landscape transformer;
one or more low voltage landscape light fixtures electrically coupled to a low voltage power line extending from the transformer; and
a control device operably coupled to the transformer, the control device including a motion detection sensor which, when activated, causes the control device to send a signal to the transformer to power and illuminate the one or more landscape light fixtures.

2. The system of claim 1, wherein the control device includes a selectable timer for actuating the transformer to power the landscape light fixtures during or for a selected period of time.

3. The system of claim 1, wherein the control device includes a photocell for actuating the transformer when ambient light falls below a predetermined level.

4. The system of claim 1, wherein the control device is electrically coupled to the low voltage power line for electrically charging a rechargeable battery of the control device.

5. The system of claim 1, wherein the motion detection sensor comprises a passive, infrared motion sensor.

6. The system of claim 1, including a stake extending from the control device for selectively positioning the control device in the ground.

7. The system of claim 1, wherein the control device includes apertures for mounting the control device on a wall or other generally vertical surface.

8. A method of providing security lighting, comprising the steps of:
providing one or more low voltage landscape light fixtures electrically coupled to a low voltage landscape transformer via a low voltage power line extending from the transformer;
coupling a control device having a motion detection sensor to the transformer; and
activating the transformer to provide power to and illuminate the landscape light fixtures when the sensor detects motion.

9. The method of claim 8, including the step of providing power to the landscape light fixtures for a predetermined period of time.

10. The method of claim 8, including the step of the control device activating the transformer when a photocell of the control device detects ambient light falling below a predetermined level.

11. The method of claim 8, including the step of recharging a battery of the control device using low voltage electricity from the transformer.

12. The method of claim 8, including the step of mounting the control device near an area to be monitored for passersby.

13. The method of claim 8, including the step of replacing a photo cell coupled to the transformer with the control device.
